(19) United States
(12) Patent Application Publication
(10) Pub. No.: US 2025/0349965 A1
(43) Pub. Date: Nov. 13, 2025

(54) TERMINAL COVERING FILM AND SECONDARY BATTERY COMPRISING THE TERMINAL COVERING FILM

(71) Applicant: SAMSUNG SDI CO., LTD., Yongin-si (KR)

(72) Inventor: Jeawoan LEE, Yongin-si (KR)

(21) Appl. No.: 19/008,730

(22) Filed: Jan. 3, 2025

(30) Foreign Application Priority Data
May 8, 2024 (KR) 10-2024-0060719

(51) Int. Cl. H01M 50/342; H01M 10/0525; H01M 50/375; H01M 50/524; H01M 50/526; H01M 50/553

(52) U.S. Cl. CPC H01M 50/342; H01M 10/0525; H01M 50/375; H01M 50/524; H01M 50/526; H01M 50/553; H01M 2200/10

(57) ABSTRACT

The present disclosure relates to a terminal covering film and a secondary battery including the terminal covering film. The terminal covering film according may include an outermost layer in contact with a case of the secondary battery, an innermost layer in contact with the electrode terminal of the secondary battery, and an intermediate layer disposed between the outermost layer and the innermost layer. A melting point of the innermost layer is lower than a melting point of the outermost layer and a melting point of the intermediate layer. The terminal covering film facilitates venting of gases from the secondary battery.

### CROSS-REFERENCE TO RELATED APPLICATION

This application claims priority under 35 U.S.C. § 119 to Korean Patent Application No. 10-2024-0060719, filed in the Korean Intellectual Property Office on May 8, 2024, the entire contents of which are hereby incorporated by reference.

### BACKGROUND

### Field

Aspects of embodiments of the present disclosure relate to a terminal covering film and a secondary battery including the terminal covering film. More particularly, aspects of the present disclosure relate to a terminal covering film for covering a terminal connected to an electrode assembly of a secondary battery and the secondary battery including the terminal covering film.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

As a type of secondary battery, lithium-ion secondary batteries are widely used. If lithium-ion secondary batteries are continuously exposed to high temperatures or are charged or discharged with high currents, internal gases can be generated due to cell degradation and other factors. The internal gases generated in the lithium-ion secondary batteries can further deteriorate cell performance. Moreover, internal pressure within a case is increased due to the internal gases. Thus, an outer shape of the cell may be deformed or the electrode assembly in the case may be damaged, which can lead to a risk of ignition.

In some forms of secondary batteries, vent components can be placed inside the secondary batteries to avoid these problems. The vent component functions to release gases generated inside the case to outside of the case when a certain internal pressure is reached. However, in some other forms of secondary batteries, it is difficult to adopt such vent components for the secondary batteries because of material or structural limitations.

Various efforts have been made to suppress the generation of internal gases in secondary batteries, to detect the generation of internal gases quickly, or to vent the internal gases safely and efficiently.

The above information disclosed in this Background section is for enhancement of understanding of the background of the present disclosure, and therefore, it may contain information that does not constitute related (or prior) art.

### SUMMARY

Embodiments of the present disclosure provide a terminal covering film and a secondary battery including the terminal film to solve the above-described problems.

More particularly, embodiments of the present disclosure provide a secondary battery that facilitates venting of internal gases and a terminal covering film for covering the electrode terminals of the secondary battery.

These and other aspects and features of the present disclosure will be described in or will be apparent from the following description of embodiments of the present disclosure.

Aspects of embodiments provide a terminal covering film for covering an electrode terminal of a secondary battery. The terminal covering film includes an outermost layer configured to contact a case of the secondary battery, an innermost layer configured to contact the electrode terminal of the secondary battery, and an intermediate layer disposed between the outermost layer and the innermost layer. Further, a melting point of the innermost layer is lower than a melting point of the outermost layer and a melting point of the intermediate layer.

According to one embodiment, the melting point of the intermediate layer may be higher than the melting point of the outermost layer and the melting point of the innermost layer.

According to one embodiment, the melting point of the outermost layer may be higher than the melting point of the innermost layer and lower than the melting point of the intermediate layer.

According to one embodiment, the melting point of the innermost layer may be in a range from 100° C. and 125° C.

According to one embodiment, the melting point of the outermost layer may be in a range from 130° C. and 140° C.

According to one embodiment, the melting point of the intermediate layer may be in a range from 155° C. and 180° C.

According to one embodiment, the innermost layer may include at least one of polyethylene, modified polyethylene, and casted polypropylene.

According to one embodiment, the outermost layer may include at least one of polyethylene, and casted polypropylene.

According to one embodiment, the intermediate layer may include at least one of polyurethane, polypropylene, and polyethylene terephthalate.

According to one embodiment, the intermediate layer may include a heat resistant material.

Aspects of embodiments further provide a secondary battery. The secondary battery includes an electrode assembly having at least one electrode terminal; a case accommodating the electrode assembly such that the at least one electrode terminal protrudes to outside of the case; and at least one terminal covering film covering at least a part of the at least one electrode terminal. The at least one terminal covering film includes an outermost layer in contact with the case, an innermost layer in contact with the electrode terminal, and an intermediate layer disposed between the outermost layer and the innermost layer. Further, a melting point of the innermost layer is lower than a melting point of the outermost layer and a melting point of the intermediate layer.

According to one embodiment, the at least one terminal covering film may be attached to the case and the at least one electrode terminal to form a seal between the case and the at least one electrode terminal.

According to one embodiment, the at least one electrode terminal may include a positive electrode terminal and a negative electrode terminal, and the at least one terminal covering film may include a first film covering at least a part of the positive electrode terminal; and a second film covering at least a part of the negative electrode terminal.

According to one embodiment, the at least one terminal covering film may include a first region disposed outside of the case; and a second region disposed inside of the case.

According to one embodiment, the secondary battery may be a pouch-type lithium-ion secondary battery.

According to one embodiment, the melting point of the intermediate layer may be higher than the melting point of the outermost layer and the melting point of the innermost layer.

According to one embodiment, the melting point of the innermost layer may be in a range from 100° C. and 125° C.

According to one embodiment, the innermost layer may include at least one of polyethylene, modified polyethylene, casted polypropylene.

According to one embodiment, the outermost layer may include at least one of polyethylene, and casted polypropylene.

According to one embodiment, the intermediate layer may include one at least one of polyurethane, polypropylene, and polyethylene terephthalate.

According to some embodiments of the present disclosure, it is possible to provide a secondary battery that facilitates the venting of internal gases, and a terminal covering film for covering the electrode terminals of the secondary battery.

According to some embodiments of the present disclosure, it is possible to provide the terminal covering film and the secondary battery including the terminal covering film in which some layers in contact with the case of the secondary battery can melt when an internal or external temperature of the secondary battery is increased above a predetermined temperature value.

According to some embodiments of the present disclosure, it is possible to prevent explosion and ignition of the secondary battery in advance by ensuring that the sealing between the case and the electrode terminals of the secondary battery is quickly released in an unsafe situation.

According to some embodiments of the present disclosure, it is possible to prevent an internal short circuit between the electrode terminals of the secondary battery from occurring by preventing a rapid increase in internal pressure and the resulting deformation of the components of the secondary battery.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is an exploded perspective view of an example in which a part of a secondary battery is disassembled according to one embodiment of the present disclosure.

FIG. 2 is a plan view of a secondary battery according to one embodiment of the present disclosure.

FIG. 3 is a cross-sectional view of the secondary battery of FIG. 2 taken along a line X-X′.

FIG. 4 is a plan view of an electrode terminal and a terminal covering film according to one embodiment of the present disclosure.

FIG. 5 is a cross-sectional view showing the electrode terminal of FIG. 4 taken along a line Y-Y′.

FIG. 6 is a cross-sectional view of a terminal covering film according to one embodiment of the present disclosure.

FIG. 7 is a cross-sectional view of a terminal covering film according to another embodiment of the present disclosure.

FIG. 8 is a graph depicting temperature and voltage changes of a secondary battery in response to ambient temperature changes according to one embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

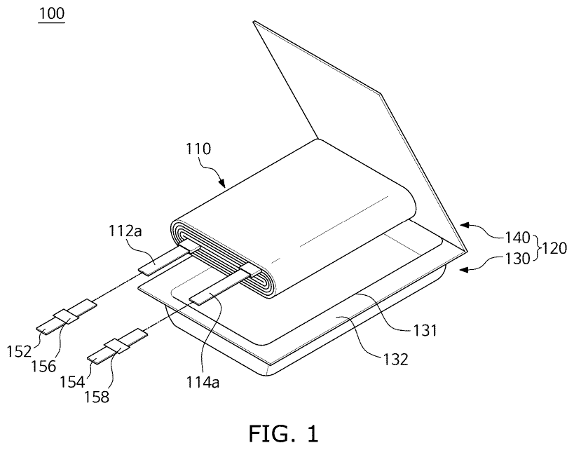

FIG. 1 is an exploded perspective view of an example in which a part of a secondary battery is disassembled according to one embodiment of the present disclosure.

A secondary battery 100 according to one embodiment includes an electrode assembly 110 and a case 120 accommodating the electrode assembly 110 therein.

The electrode assembly 110 may be formed by winding a first electrode plate and a second electrode plate with a separator interposed between the first electrode plate and the second electrode plate. However, the present disclosure is not limited to such a configuration, and the electrode assembly may have a structure in which multiple positive and negative electrodes made of sheets are stacked in alternating manner with separators between the sheets.

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but is not limited thereto.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and a combination thereof, but is not limited thereto.

The organic material and the inorganic material may be mixed in one coating layer, or a coating layer including an organic material and a coating layer including an inorganic material may be stacked.

The first electrode plate may be formed as a negative electrode plate, and the second electrode plate may be formed as a positive electrode plate, or vice versa. Specifically, in a case where the first electrode plate is formed as the negative electrode plate, the negative electrode plate is formed by coating a negative electrode active material layer containing a carbon material as a main component on opposite surfaces of the negative electrode current collector. Additionally, a negative electrode uncoated region, which is an area that is not coated with the negative electrode active material layer, is formed at opposite ends of the negative electrode current collector.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

In a case where the second electrode plate is formed as the positive electrode plate, the positive electrode plate is formed by coating a positive electrode active material layer containing lithium-based oxide as a main component on opposite surfaces of a positive electrode current collector formed from a thin aluminum foil. Additionally, a positive electrode uncoated region, which is an area that is not coated with the positive electrode active material layer, is formed at opposite ends of the positive electrode current collector.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2 -αDα (0≤a≤1.8, 0≤b≤0.5, 0≤c≤0.5, and 0<α<2); LiaNiGbO2 (0.90≤a≤1.8,0≤b≤0.9, 0≤c≤0.9, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4(0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The electrode assembly 110 may include a first electrode tab 112a formed at one side of the first electrode plate, and a second electrode tab 114a formed at one side of the second electrode plate. The first electrode tab 112a and the second electrode tab 114a may be formed by welding tabs to the uncoated regions of the first electrode plate and the second electrode plate, or by punching the uncoated regions of the first electrode plate and the second electrode plate. In a wound state, the first electrode tab 112a and the second electrode tab 114a are arranged at a constant interval in parallel to each other. In a case where the first electrode plate is formed as the negative electrode plate, the first electrode tab 112a may be formed as a negative electrode tab, and the second electrode tab 114a may be formed as a positive electrode tab. Alternatively, when the first electrode plate and the second electrode plate have opposite polarities, the first electrode tab 112a may be formed as the positive electrode tab and the second electrode tab 114a may be formed as the negative electrode tab.

The first electrode tab 112a and the second electrode tab 114a may be respectively coupled with a first electrode terminal 152 and a second electrode terminal 154 to allow the electrode assembly 110 to be electrically connected to outside of the secondary battery 100. Parts of the first and second electrode terminals 152 and 154 may be exposed to outside of the case 120. In the following description, when both of the first electrode tab 112a and the second electrode tab 114a are described, they will be collectively referred to as the electrode tabs 112a and 114a. Similarly, when both of the first electrode terminal 152 and the second electrode terminal 154 are described, they will be collectively referred to as the electrode terminals 152 and 154. The electrode tabs 112a and 114a and the electrode terminals 152 and 154 are generally made of a metal, such as aluminum, copper, or nickel. In order to minimize a voltage drop, the metal used may have electrical conductivity exceeding a predetermined level.

The electrode terminals 152 and 154 may respectively include terminal covering films 156 and 158 located on one or both of the top and bottom surfaces of the electrode terminals 152 and 154. Terminal covering films 156 and 158 may be attached to portions of the electrode terminals 152 and 154 that contact sealing portions at the edges of the case 120.

The case 120 may form the exterior of the secondary battery 100. The case 120 may be formed of a conductive metal such as aluminum, an aluminum alloy, or nickel-plated steel. The case 120 may provide a space in which the electrode assembly is accommodated. In one embodiment, the case 120 may be a pouch-type case, and the secondary battery 100 may be a pouch-type secondary battery. However, the scope of the present disclosure is not limited thereto, and the secondary battery 100 may be a battery cell having any shape, such as prismatic, cylindrical, or the like.

In one embodiment, the case 120 may include an upper case 140 and a lower case 130 integrally formed by folding at a center of a substantially rectangular case layer in a lengthwise direction, i.e., providing a fold at one side of the substantially rectangular case layer. A receiving part 131 in which the electrode assembly 110 is accommodated is formed in a central area of the lower case 130 by, for example, press processing. An extension part 132 extending in four directions is formed at the upper peripheral edge of the receiving part 131.

The lower case 130 may be coupled with an open end of the upper case 140 to seal the upper case 140. In one embodiment, one side of the lower case 130 may be open, and the upper case 140 may seal the open side of the lower case 130.

The case 120 may include an electrolyte injection opening (not shown). For example, the electrolyte injection opening may be a through hole formed in the case 120. After the upper case 140 is coupled and sealed to the opening of the lower case 130, the electrolyte injection opening may be formed to inject the electrolyte into the case 120. The electrolyte injection opening may be sealed with a sealing member after the completion of the electrolyte injection.

The secondary battery 100 may be a lithium battery cell (e.g., lithium-ion battery cell), a sodium battery cell, or the like. However, the scope of the present disclosure is not limited to such types of batteries, and the secondary battery 100 may be formed as any battery cell capable of repeatedly providing electrical power through charging and discharging operations. In a case where the secondary battery 100 is a lithium battery cell, the secondary battery 100 may be used in an electric vehicle (EV) due to its excellent life cycle and high-rate performance. Further, the lithium battery cell can be used in a hybrid vehicle such as a plug-in hybrid electric vehicle (PHEV). Still further, the lithium battery cell may be used in applications where a large amount of power storage is required. For example, the lithium battery cell may be used in electric bicycles, power tools, and the like.

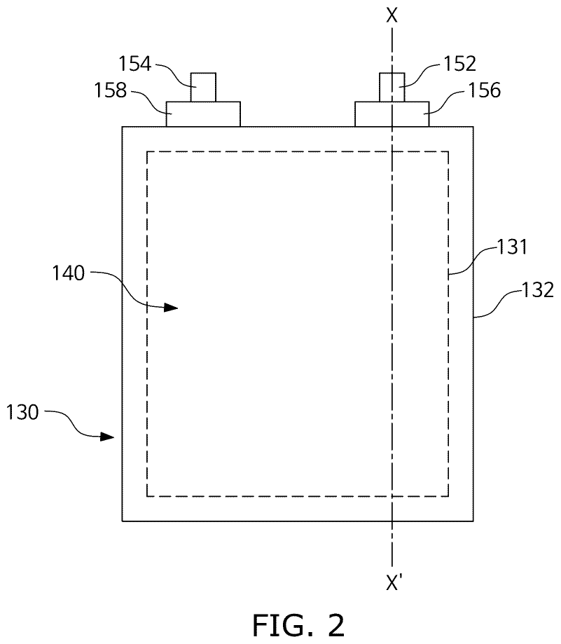

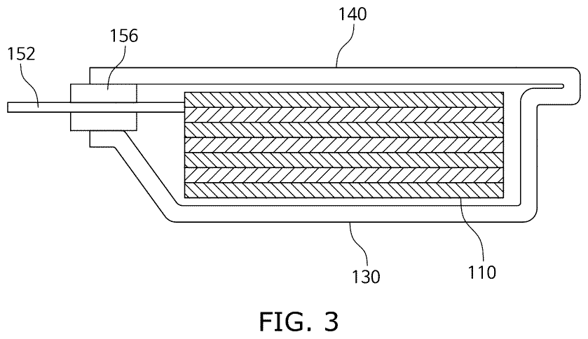

FIG. 2 is a plan view of a secondary battery according to one embodiment of the present disclosure. FIG. 3 is a cross-sectional view of the secondary battery of FIG. 2 taken along a line X-X′.

In some embodiments, the secondary battery illustrated in FIGS. 2 and 3 may be substantially the same as the secondary battery assembled from the components shown in FIG. 1. The electrode assembly 110 is placed in the receiving part 131 of the sealed case 120.

The extension part 132 of the lower case 130 may be a part remaining after forming the receiving part 131 by pressing the lower case 130, with the extension part 132 extending in a direction away from the receiving part 131. The extension part 132 may be sealed by thermally compressing the extension part 132 to a peripheral edge of the upper case 140 after the electrode assembly 110 is accommodated in the receiving part 131.

The electrode terminals 152 and 154 may protrude at least partially to outside of the case 120. For example, as shown in FIG. 2, at least a portion of each of the electrode terminals 152 and 154 may protrude beyond the top of the case 120 in an upward direction.

The extension part 132 may include a sealing surface formed to extend in a direction in which the electrode terminals 152 and 154 extend. The sealing surface may correspond to an upper regions of the extension part 132. During the sealing of the upper case 140 and the lower case 130, the sealing surface may contact the terminal covering films 156 and 158 that surround the electrode terminals 152 and 154.

In some embodiments, the terminal covering films 156 and 158 may protrude at least partially to outside of the case 120. For example, as shown in FIG. 2, at least a portion of each of the terminal covering films 156 and 158 may protrude beyond the top of the case 120 in an upward direction. However, the scope of the present disclosure is not limited to the depicted configuration. For example, the terminal covering films 156 and 158 may not be exposed to outside of the case 120.

In some embodiments, the terminal covering films 156 and 158 may be disposed to cover the sealing surface of the case 120. Referring to FIG. 3, in a direction in which the electrode terminals 152 and 154 extend (left-right direction in FIG. 3), a length of each of the terminal covering films 156 and 158 may be equal to or greater than a length of the sealing surface of the case 120. Further, in the direction in which the electrode terminals 152 and 154 extend, a distance between an outer end and an inner end of each of the electrode terminals 152 and 154 may be equal to or greater than a distance between an outer end and an inner end of the extension part 132.

In one embodiment, an outer end of each of the terminal covering films 156 and 158 may be positioned outward relative to an outer end of the sealing surface. Further, an inner end of each of the terminal covering films 156 and 158 may be positioned inward relative to an inner end of the sealing surface. In another embodiment, the outer end of each of the terminal covering films 156 and 158 may be positioned at the same location as the outer end of the sealing surface, and the inner end of each of the terminal covering films 156 and 158 may be positioned inward relative to the inner end of the sealing surface. In another embodiment, the outer end of each of the terminal covering films 156 and 158 may be positioned inward relative to the outer end of the sealing surface, and the inner end of each of the terminal covering films 156 and 158 may be positioned in the same location as the inner end of the sealing surface. In yet another embodiment, the outer end of each of the terminal covering films 156 and 158 may be positioned at the same location as the outer end of the sealing surface, and the inner end of each of the terminal covering films 156 and 158 may be positioned at the same location as the inner end of the sealing surface.

In one embodiment, when sealing the upper case 140 and the lower case 130, the sealing may be performed at a temperature ranging from approximately 180° C. to 220° C. The processing temperature at which the sealing is performed may be higher than the melting temperatures of the terminal covering films 156 and 158. The time for which heat is applied to the case 120 for sealing may be only about 2 to 3 seconds. By applying heat for such a relatively short period of time, melting of the terminal covering films during sealing can be prevented.

In one embodiment of the present disclosure, the terminal covering films 156 and 158 may have a shape and size corresponding to the area of a contact region where the electrode terminals 152 and 154 and the case 120 are in contact. Under normal operating conditions of the secondary battery 100, the terminal covering films 156 and 158 may form a seal between the electrode terminals 152 and 154 and the case 120. Thus, the terminal covering films 156 and 158 may prevent foreign substances from entering the interior of the secondary battery 100.

Under certain conditions or specific environmental conditions that are not the normal operating conditions, the secondary battery 100 may operate abnormally, causing the electrode terminals 152 and 154 to overheat. In such cases, the terminal covering films 156 and 158 may be at least partially melted due to the heat generated by the electrode terminals 152 and 154. As a result of the partial melting of the terminal covering films 156 and 158, a gap or a fine flow path may be formed between the case 120 and the electrode terminals 152 and 154. This gap or the fine flow path may allow gases generated inside the secondary battery 100 to be released to outside of the secondary battery 100. In other words, the terminal covering films 156 and 158 may provide for a safety vent in the sealing region of the case 120.

A thickness of the terminal covering film 156 (i.e., a distance in the up-down (vertical) direction in FIG. 3) may be substantially the same as a vertical distance between the electrode terminals 152 and 154 and the case 120. In one embodiment, the terminal covering film 156 may be initially formed to have a thickness greater than the vertical distance between the electrode terminals 152 and 154 and the case 120, and then the thickness of the terminal covering film 156 may be partially reduced during the sealing process of the case 120. In another embodiment, the terminal covering film 156 may be formed to have a thickness substantially the same as the vertical distance between the electrode terminals 152 and 154 and the case 120 prior to the sealing process.

In one embodiment, the electrode terminals 152 and 154 may generate a greater amount of heat compared to other components of the secondary battery 100. The terminal covering films 156 may be formed in direct contact with the electrode terminals 152 and 154 generating heat. Due to this configuration, the terminal covering film 156 may respond relatively quickly to the temperature rise of the secondary battery 100 compared to films formed in other components of the secondary battery 100.

In some embodiments, the case 120 may include a case layer for preventing damage to an outer surface thereof or for insulation from external elements. The case layer may be formed on the outermost layer of the case 120 and may include materials such as a metal thin film, an insulating resin, or a thermally adhesive synthetic resin. A substrate (or innermost layer) of the case 120 is in contact with the terminal covering films 156 and 158. The substrate of the case 120 may include materials that are the same as or similar to the materials of the terminal covering films 156 and 158. These material features may increase the adhesion between the substrate of the case 120 and the terminal covering films 156 and 158 at the sealing portion during the sealing process of the case 120.

Referring to FIG. 2, the terminal covering films 156 and 158 are formed on both of the first electrode terminal 152 and the second electrode terminal 154. However, the scope of the present disclosure is not limited to the depicted configuration. For example, in one embodiment, the terminal covering film may be formed on only one of the first electrode terminal 152 and the second electrode terminal 154. In another embodiment, the terminal covering film may be formed only on the positive electrode terminal, which may have greater heat generation than the negative electrode terminal, and the terminal covering film may not be formed on the negative electrode terminal.

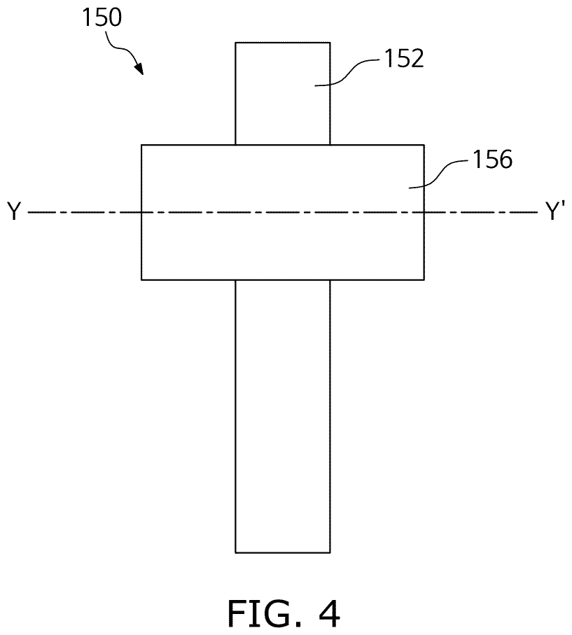

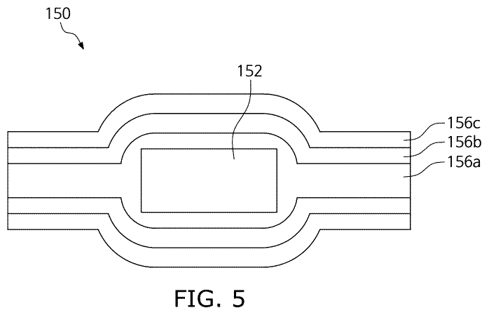

FIG. 4 is a plan view of an electrode terminal and a terminal covering film according to one embodiment of the present disclosure. FIG. 5 is a cross-sectional view showing the electrode terminal of FIG. 4 taken along a line Y-Y′.

The terminal covering film 156 according to one embodiment of the present disclosure may include a plurality of layers. Referring to FIGS. 4 and 5, the terminal covering film 156 may include an outermost layer 156c in contact with the case 120, an innermost layer 156a in contact with the electrode terminal 152, and an intermediate layer 156b disposed between the outermost layer 156c and the innermost layer 156a.

The innermost layer 156a of the terminal covering film according to one embodiment of the present disclosure may have a lower melting point compared to the intermediate layer 156b and the outermost layer 156c of the terminal covering film. As described above, under certain conditions or specific environmental conditions, the electrode terminal 152 may be overheated. The innermost layer 156a, which has a relatively lower melting point, may begin to melt earlier than the intermediate layer 156b and the outermost layer 156c. As a result, a fine gap or a flow path may be formed between the case 120 and the electrode terminal 152, which may allow gases generated inside the case 120 to be released to outside of the case 120.

The melting point of the innermost layer 156a according to one embodiment of the present disclosure may range from 100° C. to 125° C. Further, the innermost layer 156a may include any one of polyethylene, modified polyethylene, casted polypropylene, and a mixture of these materials.

In some embodiments, the innermost layer 156a may be formed of a polyethylene (PE)-based resin. The polyethylene (PE)-based resin may burn when it melts. Therefore, at least a partial region of the innermost layer 156a formed of the PE-based resin may melt and burn when the electrode terminal 152 is heated to a temperature greater than or equal to the melting point of the innermost layer 156a. The burnt partial region of the innermost layer 156a may allow fluid communication between the interior and exterior of the case 120. As a result, if gases are generated inside the case 120, the gases may be released to outside of the case 120 through the burnt partial region of the innermost layer 156a.

In some embodiments, the innermost layer 156a of the terminal covering film may be formed of low-density polyethylene (LDPE). The low-density polyethylene (LDPE) may refer to polyethylene (PE) having a density ranging from approximately 0.91 to 0.925. The low-density polyethylene (LDPE) may have a relatively low melting point ranging from approximately 100° C. to 115° C.

In some embodiments, the innermost layer 156a of the terminal covering film may be formed of linear low-density polyethylene (LLDPE). The linear low-density polyethylene (LLDPE) may refer to polyethylene (PE) having a density ranging from of approximately 0.926 to 0.940. The linear low-density polyethylene (LLDPE) may have a melting point ranging from approximately 115° C. to 125° C.

At least a portion of the innermost layer 156a of the terminal covering film may melt as the temperature of the electrode terminal 152 increases. In this configuration, a space may be formed between the electrode terminal 152 and the intermediate layer 156b of the terminal covering film. The space may allow gases generated inside the case 120 to be released to outside of the case 120.

Referring to FIGS. 4 and 5, the terminal covering film 156 may have a shape similar to a rectangular parallelepiped with rounded corners. However, the scope of the present disclosure is not to be limited to such a shape. For example, the shape of the terminal covering film 156 may be circular, semicircular, inverted triangular, polygonal, or any other shape.

In some embodiments, the melting point of the outermost layer 156c and the melting point of the intermediate layer 156b may be higher than the melting point of the innermost layer 156a. The melting point of the intermediate layer 156b may be higher than the melting point of the outermost layer 156c and the melting point of the innermost layer 156a. For example, the melting point of the outermost layer 156c may range from 130° C. to 140° C. The melting point of the intermediate layer 156b may range from 155° C. to 180° C.

The outermost layer 156c may include any one of polyethylene, casted polypropylene, and a mixture thereof. Further, the intermediate layer 156b may include any one of polyurethane, polypropylene, polyethylene terephthalate, and a mixture thereof.

In some embodiments, the intermediate layer 156b and the outermost layer 156c of the terminal covering film may each include casted polypropylene (CPP) formed from a group of polypropylenes (PP) that is a thermally adhesive synthetic resin. Polypropylene (PP)-based resin may have a melting point ranging from approximately 130° C. to 171° C.

FIGS. 4 and 5 illustrate a single terminal covering film 156. However, this is only for convenience of illustration and the scope of the present disclosure is not limited thereto. The secondary battery 100 according to one embodiment of the present disclosure may include two terminal covering films 156 and 158 that contact two electrode terminals 152 and 154, respectively. In some embodiments, the terminal covering film 156 contacting the first electrode terminal 152 may differ from the terminal covering film 158 contacting the second electrode terminal 154 in at least one of shape, length, thickness, cross-sectional shape, and material.

FIG. 5 illustrates the terminal covering film 156 surrounding the entire circumference of the electrode terminal 152. However, the scope of the present disclosure is not limited to such a configuration. The secondary battery 100 according to one embodiment of the present disclosure may include a terminal covering film that surrounds a part of the circumference of the electrode terminal 152.

As described above, in the secondary battery 100 according to embodiments of the present disclosure, when the electrode terminals 152 and 154 are overheated, the innermost layer 156a of the terminal covering film melt before the sealing portion of the case 120, the intermediate layer 156b of the terminal covering film, and the outermost layer 156c of the terminal covering film. This particular configuration may provide for a safety vent in the secondary battery 100. In other words, by including the innermost layer 156a having the melting point and material characteristics described above, the secondary battery according to embodiments of the present disclosure may prevent the risk of explosion or ignition that may occur upon overheating of the electrode terminals 152 and 154 due to abnormal operation of the secondary battery.

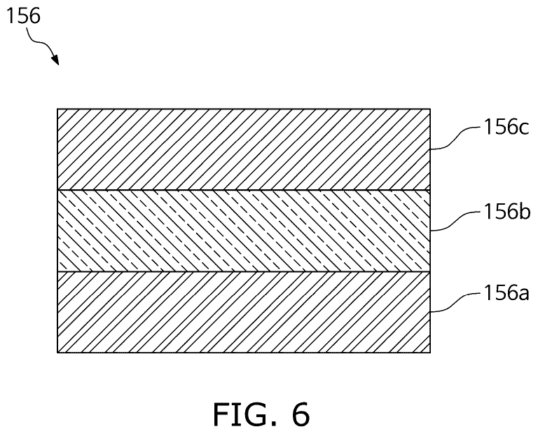

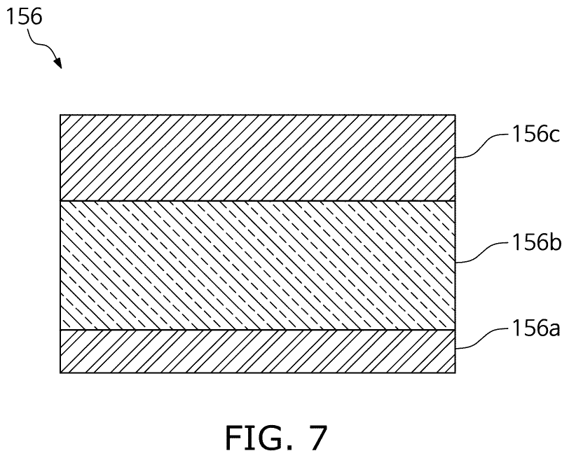

FIG. 6 is a cross-sectional view of a terminal covering film according to one embodiment of the present disclosure. Further, FIG. 7 is a cross-sectional view of a terminal covering film according to another embodiment of the present disclosure.

The melting point of the innermost layer 156a according to one embodiment of the present disclosure may range from 100° C. to 125° C. This temperature range may be associated with venting internal gases that may be generated inside the case 120 when the temperature of the secondary battery 100 increases. Further, this temperature range may also be associated with preventing ignition and minimizing voltage drop in the secondary battery 100.

As a comparative example, a battery may be configured where the melting point of the innermost layer 156a is less than 100° C. In the comparative example, the innermost layer 156a may melt even under temperature conditions below 100° C. With this configuration, the seal between the case 120 and the electrode terminals 152 and 154 may be broken. For example, the secondary battery 100 according to the comparative example may not be stored in high temperature and high humidity conditions of 85° C., which is the standard for high-temperature environmental evaluation required for the normal operation of the secondary battery 100. Therefore, in embodiments of the present disclosure, it is desirable that the melting point of the innermost layer 156a, which is in direct contact with the electrode terminals 152 and 154, be 100° C. or higher in consideration of the standard for high-temperature environment evaluation, temperature dispersion, and the like.

As another comparative example, a battery may be configured where the melting point of the innermost layer 156a exceeds 125° C. In this comparative example, the innermost layer 156a may not melt even under temperature conditions exceeding 125° C. A heating evaluation in temperature environmental characteristics can be conducted at 130° C. Under the 130° C. condition, if the sealing strength between the case 120 and the electrode terminals 152 and 154 is too strong, internal short circuits may occur due to deformation of the electrode assembly 110, potentially leading to a fire caused by cell ignition. Therefore, to prevent fires under such conditions, it may be necessary to reduce the internal pressure before an internal short circuit occurs. Thus, in the embodiments of the present disclosure, it is desirable that the melting point of the innermost layer 156a is 125° C. or below in consideration of the standard for heating evaluation, temperature distribution, and the like.

In view of the melting point characteristics described above, the innermost layer 156a may include one of the following: polyethylene including low density polyethylene (LDPE) and linear low-density polyethylene (LLDPE); ethylene-vinyl acetate copolymer; modified polyethylene including maleic anhydride-grafted polyethylene and acrylic acid-grafted polyethylene; casted polypropylene (CPP); and a mixture of these materials.

The melting point of the intermediate layer 156b according to one embodiment of the present disclosure may be 155° C. or higher. Such a temperature may be associated with resistance to temperature distribution and the like during the sealing process of the secondary battery 100. The sealing process between the upper case 140 and the lower case 130 and the sealing process between the case 120 and the electrode terminals 152 and 154 may be carried out at a temperature range of approximately 180° C. to 220° C. The processing temperature at which the sealing is performed may be higher than the melting point of the terminal covering film 156. The heat application time for sealing the case 120 may be approximately 2 to 3 seconds. To prevent the innermost layer 156a from melting during the sealing process, the intermediate layer 156b may need to prevent heat from reaching the innermost layer 156a. Further, when the metal layers of the electrode terminals 152 and 154 and the metal layer of the substrate of the case 120 are connected to each other, corrosion of the metal layer of the case 120 may occur. Such corrosion may adversely affect the safety of the secondary battery 100. Therefore, in embodiments of the present disclosure, it is desirable that the melting point of the intermediate layer 156b disposed between the innermost layer 156a and the outermost layer 156c be 155° C. or higher in consideration of heat dissipation to the innermost layer 156a, prevention of corrosion phenomena, temperature deviation, and the like.

In view of the melting point characteristics described above, the intermediate layer 156b may include a heat resistant material. Further, the intermediate layer 156b may include one of the following: poly urethane; polypropylene including casted polypropylene (CPP) and oriented polypropylene (OPP); polyethylene terephthalate (PET); and a mixture of these materials.

The melting point of the outermost layer 156C according to one embodiment of the present disclosure may range from 130° C. to 140° C. This temperature range may be associated with the quality of the sealing with the case 120. The sealing process between the upper case 140 and the lower case 130 and the sealing process between the case 120 and the electrode terminals 152 and 154 may be carried out at a temperature range of approximately 180° C. to 220° C. To improve the quality of the sealing with the case 120, the melting point of the outermost layer 156c may be maintained at a level of 140° C., which is the melting point of the casted polypropylene (CPP) layer that can be used as the substrate of the case 120.

As a comparative example, a battery may be configured where the melting point of the outermost layer 156c exceeds 140° C. In the comparative example, it is necessary to increase the temperature of a sealing plate that is used in the sealing process. In such a case, the uniformity of the terminal covering film 156 may deteriorate due to complete melting of the casted polypropylene (CPP) layer, which is the substrate of the case 120. Therefore, in embodiments of the present disclosure, it is desirable that the melting point of the outermost layer 156c is 140° C. or less in consideration of the quality of sealing with the case 120, the complete melting of the substrate of the case 120, the deterioration of the uniformity of the terminal covering film 156, and the like.

As another comparative example of the present disclosure, a battery may be configured where the melting point of the outermost layer 156c is less than 130° C. In the comparative example, the outermost layer 156c may melt excessively or transfer excessive heat to the innermost layer 156a of the terminal covering film. Therefore, in embodiments of the present disclosure, it is desirable that the melting point of the outermost layer 156c is 130° C. or higher in consideration of excessive melting, heat transfer to the innermost layer 156a, and the like.

In connection with the melting point characteristics described above, the outermost layer 156c may include one of the following: polyethylene including high density polyethylene (HDPE), casted polypropylene (CPP), and a mixture of these materials.

Each layer of the terminal covering film 156 according to embodiments of the present disclosure may have the melting point characteristics and the material characteristics as described above. With this distinctive configuration, the terminal covering film 156 may satisfy requirements for sealing of the terminal covering film 156 to the case 120, preventing over-sealing of the electrode terminals 152 and 154, and provide for a safety vent when the temperature is raised above a predetermined level.

In some embodiments, the material of each layer of the terminal covering film 156 may include polymers. In the case of polymers, the melting point may vary to some extent depending on adjustments to the molecular weight, biaxial stretching or non-stretching, and the type of monomer or polymer material initially used. Accordingly, the polymer can be adjusted and used to meet the required characteristics for forming the terminal covering film 156.

In some embodiments, the plurality of layers included in the terminal covering film 156 may have various thicknesses. Referring to FIG. 6, the thicknesses of the innermost layer 156a, the intermediate layer 156b, and the outermost layer 156c may be the same as each other. But the present disclosure is not limited to such a configuration. For example, referring to FIG. 7, the thickness of the intermediate layer 156b may be greater than the thickness of the innermost layer 156a and the outermost layer 156c. Further, the thickness of the outermost layer 156c may be greater than the thickness of the innermost layer 156a.

As compared to the embodiment of FIG. 6, in the embodiment of FIG. 7 a reduction in the thickness of the innermost layer 156a may lead to quicker melting and a more sensitive response to a temperature increase of the electrode terminal 152. As a result, gases inside the case 120 may be vented before the internal pressure of the case 120 affects the secondary battery 100. Furthermore, according to the embodiment of FIG. 7, the increased thickness of the intermediate layer 156b of the terminal covering film may prevent excessive heat transfer to the innermost layer 156a of the terminal covering film when sealing with the case 120. However, the relative thickness of each layer of the terminal covering film in the present disclosure is not limited to the embodiments shown in FIGS. 6 and 7.

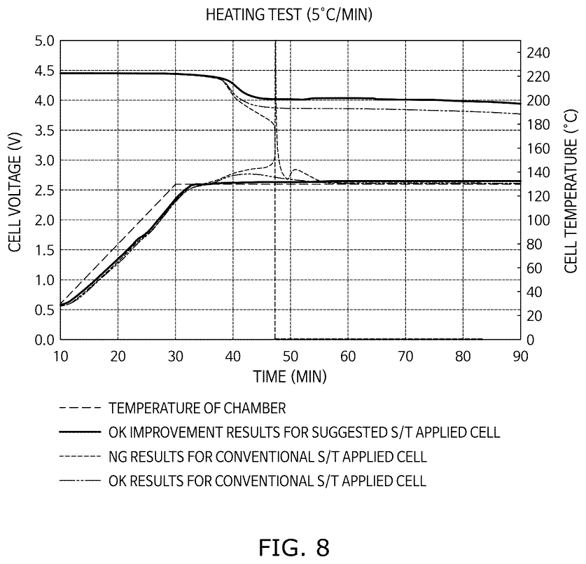

FIG. 8 is a graph depicting temperature and voltage changes of a secondary battery in response to ambient temperature changes according to one embodiment of the present disclosure.

FIG. 8 shows heating test results for various types of secondary batteries. A heating test may include placing a secondary battery that is a test target in a chamber, increasing a temperature of the chamber, and recording the temperature and voltage changes of the secondary battery. For example, the temperature of the chamber may be increased at a rate of 5° C. per minute up to 130° C.

As the heating test progresses, the temperature and pressure of the secondary battery placed in the chamber may increase. The internal pressure inside the secondary battery may increase due to gas generation, and if the internal gas cannot be vented to the outside, the case may inflate like a balloon. Further, if the deformation of the case causes physical strain on the electrode assembly placed inside the case, a short circuit may occur.

In the conventional secondary batteries, there may be a rapid increase in temperature and internal voltage. The rapid increase in temperature and pressure may result in a short circuit or instantaneous ignition of the internal electrode assembly.

In contrast, the configuration of the secondary battery 100 according to the embodiments of the present disclosure is such that the temperature and internal pressure remain stable. This stability can be attributed to the fact that when the temperature of the chamber is increased to a temperature of approximately 100° C. to 125° C., the innermost layer 156a of each of the terminal covering films 156 and 158 adhered to the electrode terminals 152 and 154 at least partially melts, allowing the internal gases to be vented to outside of the case 120. In other words, according to the embodiments of the present disclosure, even if a rapid temperature rise occurs around the secondary battery 100 or a high temperature state is maintained for an extended period, the secondary battery 100 can suppress short circuits and ignition, thereby improving safety.

In some embodiments, the case 120 may have various shapes, such as a prismatic shape, a pouch shape, a cylindrical shape, or the like. When the case 120 has a pouch-shaped battery, it can be used in a mobile phone. During prolonged use or charging, a mobile phone may experience a rapid temperature rise or maintain a high temperature for an extended period, subjecting it to conditions similar to those of a heating test for a secondary battery. For mobile phones that are closely related to daily life, the importance of safety in the mobile phones is paramount, and the present disclosure provides the secondary battery capable of significantly improving the safety of mobile phones.

Although the present disclosure has been described above with respect to embodiments thereof, the present disclosure is not limited thereto. Various modifications and variations can be made thereto by those skilled in the art within the spirit of the present disclosure.

### Explanation of Reference Symbols

100: secondary battery
110: electrode assembly
120: case
130: lower case
140: upper case
112a, 114a: electrode tab
152, 154: electrode terminal
156, 158: terminal covering film
156a: innermost layer
156b: innermost layer
156c: outermost layer

1. A terminal covering film for covering an electrode terminal of a secondary battery, the terminal covering film comprising:
an outermost layer configured to contact a case of the secondary battery;
an innermost layer configured to contact the electrode terminal of the secondary battery; and
an intermediate layer disposed between the outermost layer and the innermost layer,
wherein a melting point of the innermost layer is lower than a melting point of the outermost layer and a melting point of the intermediate layer,
wherein the melting point of the innermost layer is in a range from 100° C. to 120° C.,
wherein a thickness of the intermediate layer is greater than a thickness of the innermost layer and a thickness of the outermost layer, and
wherein the thickness of the outermost layer is greater than the thickness of the innermost layer.

2. The terminal covering film as claimed in claim 1, wherein the melting point of the intermediate layer is higher than the melting point of the outermost layer and the melting point of the innermost layer.

3. A terminal covering film for covering an electrode terminal of a secondary battery, the terminal covering film comprising:
an outermost layer configured to contact a case of the secondary battery;
an innermost layer configured to contact the electrode terminal of the secondary battery; and
an intermediate layer disposed between the outermost layer and the innermost layer,
wherein a melting point of the innermost layer is lower than a melting point of the outermost layer and a melting point of the intermediate layer,
wherein the melting point of the innermost layer is in a range from 100° C. to 120° C.,
wherein a thickness of the intermediate layer is greater than a thickness of the innermost layer and a thickness of the outermost layer,
wherein the thickness of the outermost layer is greater than the thickness of the innermost layer, and
wherein the melting point of the outermost layer is higher than the melting point of the innermost layer and lower than the melting point of the intermediate layer.

4. (canceled)

5. The terminal covering film as claimed in claim 1, wherein the melting point of the outermost layer is in a range from 130° C. and 140° C.

6. The terminal covering film as claimed in claim 1, wherein the melting point of the intermediate layer is in a range from 155° C. and 180° C.

7. The terminal covering film as claimed in claim 1, wherein the innermost layer comprises at least one of polyethylene, modified polyethylene, and casted polypropylene.

8. The terminal covering film as claimed in claim 1, wherein the outermost layer comprises at least one of polyethylene and casted polypropylene.

9. The terminal covering film as claimed in claim 1, wherein the intermediate layer comprises at least one of polyurethane, polypropylene, and polyethylene terephthalate.

10. The terminal covering film as claimed in claim 1, wherein the intermediate layer comprises a heat resistant material.

11. A secondary battery comprising:
an electrode assembly comprising at least one electrode terminal;
a case accommodating the electrode assembly such that the at least one electrode terminal protrudes outside of the case; and
at least one terminal covering film covering at least a part of the at least one electrode terminal,
wherein the at least one terminal covering film comprises:
an outermost layer in contact with the case,
an innermost layer in contact with the electrode terminal, and
an intermediate layer disposed between the outermost layer and the innermost layer, and
wherein a melting point of the innermost layer is lower than a melting point of the outermost layer and a melting point of the intermediate layer,
wherein the melting point of the innermost layer is in a range from 100° C. to 120° C.,
wherein a thickness of the intermediate layer is greater than a thickness of the innermost layer and a thickness of the outermost layer, and
wherein the thickness of the outermost layer is greater than the thickness of the innermost layer.

12. The secondary battery as claimed in claim 11, wherein the at least one terminal covering film is attached to the case and the at least one electrode terminal to form a seal between the case and the at least one electrode terminal.

13. The secondary battery as claimed in claim 11, wherein the at least one electrode terminal comprises a positive electrode terminal and a negative electrode terminal, and
wherein the at least one terminal covering film comprises a first film covering at least a part of the positive electrode terminal and a second film covering at least a part of the negative electrode terminal.

14. The secondary battery as claimed in claim 11, wherein the at least one terminal covering film comprises a first region disposed outside of the case and a second region disposed inside of the case.

15. The secondary battery as claimed in claim 11, wherein the secondary battery is a pouch-type lithium-ion secondary battery.

16. The secondary battery as claimed in claim 11, wherein the melting point of the intermediate layer is higher than the melting point of the outermost layer and the melting point of the innermost layer.

17. (canceled)

18. The secondary battery as claimed in claim 11, wherein the innermost layer comprises at least one of polyethylene, modified polyethylene, and casted polypropylene.

19. The secondary battery as claimed in claim 11, wherein the outermost layer comprises at least one of polyethylene and casted polypropylene.

20. The secondary battery as claimed in claim 11, wherein the intermediate layer comprises at least one of polyurethane, polypropylene, and polyethylene terephthalate.
